(19) United States
(12) Patent Application Publication
(10) Pub. No.: US 2019/0051300 A1
(43) Pub. Date: Feb. 14, 2019

(54) LOUDSPEAKER SYSTEM

(71) Applicant: Premium Loudspeakers (Hui Zhou) Co., Ltd., Huizhou City (CN)

(72) Inventor: Cheng Yang Liao, Taipei (TW)

(21) Appl. No.: 16/058,282

(22) Filed: Aug. 8, 2018

Related U.S. Application Data
(60) Provisional application No. 62/542,364, filed on Aug. 8, 2017.

(51) Int. Cl. G10L 15/22; G10L 21/0232; G06F 3/16; H04R 29/00

(52) U.S. Cl. CPC G10L 15/22; G10L 21/0232; G10L 2021/02082; G06F 3/167; H04R 29/001; G06F 3/165

(57) ABSTRACT

A loudspeaker system includes a host processor, a audio output unit, a motion detection module and a voice control module. The host processor is electrically connected to the audio output unit, the motion detection module and the voice control module, respectively. The motion detection module detects a motion of a user. The host processor controls an output signal of the audio output unit according to the detected motion and the voice control module receives a voice command, to enable the host processor to control an operation.

### CROSS REFERENCE TO RELATED APPLICATIONS

This nonprovisional application claims priority to U.S. Provisional Application No. 62/542,364, which was filed on Aug. 8, 2017, and which is herein incorporated by reference.

### TECHNICAL FIELD

The present disclosure relates to a loudspeaker system, and in particular, to a voice-controllable and operable loudspeaker system.

### RELATED ART

Current speakers have been developed to be operable under the control of voice. A speaker with a voice control system can be provided to allow a user to operate a speaker with natural language, to, for example, change a radio station, change a song, or check the weather.

However, the speaker is a sound playback apparatus, and when a voice-controlled operation is implemented by using voice, if the speaker also plays back a sound at the same time, the voice-controlled operation is likely to be affected. When an output sound played back by the speaker is strong (i.e. the volume is high), it is even likely that a voice control system of the speaker cannot detect a voice command of a user.

In other words, it is likely that a voice of the user needs to be louder than the sound played back by the speaker, so that the speaker may be operable under the control of voice. In this case, it is likely that the user needs to use a loud voice and repeat the voice command many times, so as to enable the voice control system of the speaker to detect the voice command of the user. It is very inconvenient to users.

### SUMMARY

In view of this, the present disclosure provides a loudspeaker system, including a host processor, an audio output unit, a motion detection module, and a voice control module. The host processor is electrically connected to the audio output unit, the motion detection module, and the voice control module respectively. The motion detection module is configured to detect a motion of a user. The host processor controls an output signal of the audio output unit according to the detected motion, and the voice control module is configured to receive a voice command, to enable the host processor to control an operation.

In an embodiment, the loudspeaker system further includes a main body, the host processor, the audio output unit, and the voice control module are disposed within the main body, and the motion detection module is a standalone unit outside of the main body.

In an embodiment, the host processor controls an output signal of the audio output unit to be volume reduction, the audio output unit is electrically connected to the voice control module, and the voice control module implements automatic echo cancellation.

The present disclosure further provides a loudspeaker system, including: a first speaker apparatus and a second speaker apparatus. The first speaker apparatus includes: a first processor and a first transceiver. The first transceiver is electrically connected to the first processor. The second speaker apparatus includes: a second transceiver, a second processor, a audio output unit, a motion detection module, and a voice control module. The second processor is electrically connected to the second transceiver, the audio output unit, the motion detection module, and the voice control module respectively. The motion detection module is configured to detect a motion of a user. The second transceiver transmits a detected motion signal detected by the motion detection module to the first transceiver, the first processor outputs a control signal according to the detected motion signal, and the control signal is transmitted through the first transceiver to the second transceiver, to enable the second processor to control the output signal of the audio output unit. The voice control module is configured to receive a voice command and transmit the voice command to the first transceiver through the second processor and the second transceiver, to enable the first processor to control an operation.

In an embodiment, the second speaker apparatus further includes a main body. The second processor, the audio output unit, and the voice control module are disposed within the main body, and the motion detection module is a standalone unit outside of the main body.

In an embodiment, the first processor controls an output signal of the audio output unit to lower the volume, the audio output unit is electrically connected to the voice control module, and the voice control module implements automatic echo cancellation.

The present disclosure further provides another loudspeaker system, including: a first speaker apparatus, a second speaker apparatus, a motion detection module, and a third transceiver. The first speaker apparatus includes: a first processor and a first transceiver. The first transceiver is electrically connected to the first processor. The second speaker apparatus includes: a second transceiver, a second processor, an audio output unit, and a voice control module. The second processor is electrically connected to the second transceiver, the audio output unit, and the voice control module respectively. The motion detection module is electrically connected to the third transceiver. The motion detection module is configured to detect a motion of a user. The third transceiver transmits a detected motion signal detected by the motion detection module to the first transceiver, the first processor outputs a control signal according to the detected motion signal, and the control signal is transmitted through the first transceiver to the second transceiver, to enable the second processor to control the output signal of the audio output unit. The voice control module receives a voice command and transmits the voice command to the first transceiver through the second processor and the second transceiver, to enable the first processor to control an operation.

In an embodiment, the first processor controls an output signal of the audio output unit to lower the volume, the audio output unit is electrically connected to the voice control module, and the voice control module implements automatic echo cancellation.

The present disclosure provides a method of controlling a speaker, including: detecting a motion of a user; adjusting an output signal of the speaker according to the detected motion; detecting a voice command of the user; and controlling an operation on the speaker according to the voice command.

In short, the loudspeaker system according to the present disclosure can control a voice command better by using a motion of a use and can, with respect to a voice-controlled loudspeaker system, provide better user experience.

### BRIEF DESCRIPTION OF THE DRAWINGS

FIG. 1 is a schematic block diagram of an embodiment of a loudspeaker system according to the present disclosure;

FIG. 2A and FIG. 2B are respectively schematic three-dimensional diagrams of a motion detection module and a loudspeaker system being integrated or running independently;

FIG. 3 is a schematic block diagram of applying a loudspeaker system according to the present disclosure to a multi-room loudspeaker system;

FIG. 4 is a schematic block diagram of applying another embodiment of a loudspeaker system according to the present disclosure to a multi-room loudspeaker system; and

FIG. 5 is a flow diagram of a method of controlling a speaker according to an exemplary embodiment of the invention.

### DETAILED DESCRIPTION

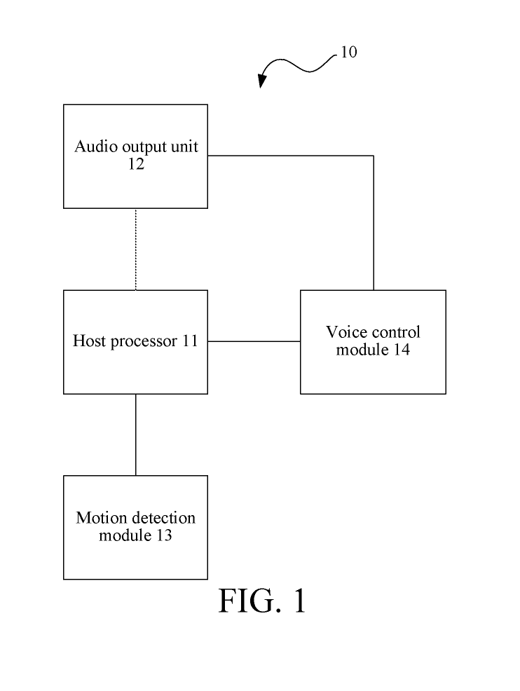

Referring to FIG. 1, the present disclosure provides a loudspeaker system 10, including a host processor 11, an audio output unit 12, a motion detection module 13, and a voice control module 14. The host processor 11 is electrically connected to the audio output unit 12, the motion detection module 13, and the voice control module 14 respectively. The motion detection module 13 detects a motion of a user. For example, the audio output unit may be a speaker, and the motion detection module 13 may be an image capturing apparatus, a camera, or the like. When the motion detection module 13 detects a motion of a user, for example, detects any set motions, such as raising up a hand, waving, shaking the hand, nodding, or jumping, of the user, the host processor 11 controls an output signal of the audio output unit 12 according to the detected motion, for example, lowers a volume of the audio output unit 12 until it is easy for the voice control module 14 to recognize the user's voice. In addition, the output signal controlling the audio output unit 12 may alternatively be equalizer parameter adjustment, multi-channel adjustment and distribution, and the like. Then, when the user controls the loudspeaker system 10 with voice operation, the voice control module 14 receives a voice command from the user, to enable the host processor 11 to control an operation on the loudspeaker system 10, for example, an operation such as switching on or off the speaker, changing a radio station, changing a song, and adjusting a melody, etc. The voice control module 14 usually includes at least one microphone (or a microphone array), configured to receive sound, and further includes a transceiver configured to receive and transmit signals, so as to implement voice control.

In an embodiment, the audio output unit 12 is electrically connected to the voice control module 14, the audio output unit 12 feeds back a sound signal to the voice control module 14, and in this case, the voice control module 14 implements automatic echo cancellation (AEC), to improve a voice recognition rate. Therefore, in some embodiments, the voice control module 14 may further include a digital signal processor (DSP) to implement necessary processing.

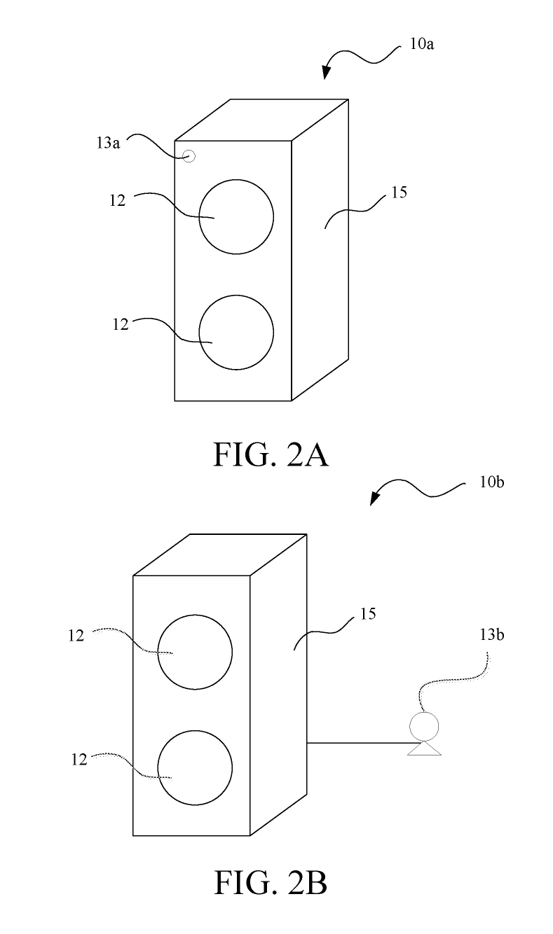

Referring to FIG. 2A, in an embodiment, a loudspeaker system 10a further includes a main body 15, where the host processor 11, the audio output unit 12, a motion detection module 13a, and the voice control module 14 are all disposed within the main body 15. However, in another embodiment, as shown in FIG. 2B, a motion detection module 13b of a loudspeaker system 10b may alternatively be a standalone accessary disposed outside of the main body 15. The motion detection module 13a may be connected in a wired or wireless manner, and detailed description is provided below.

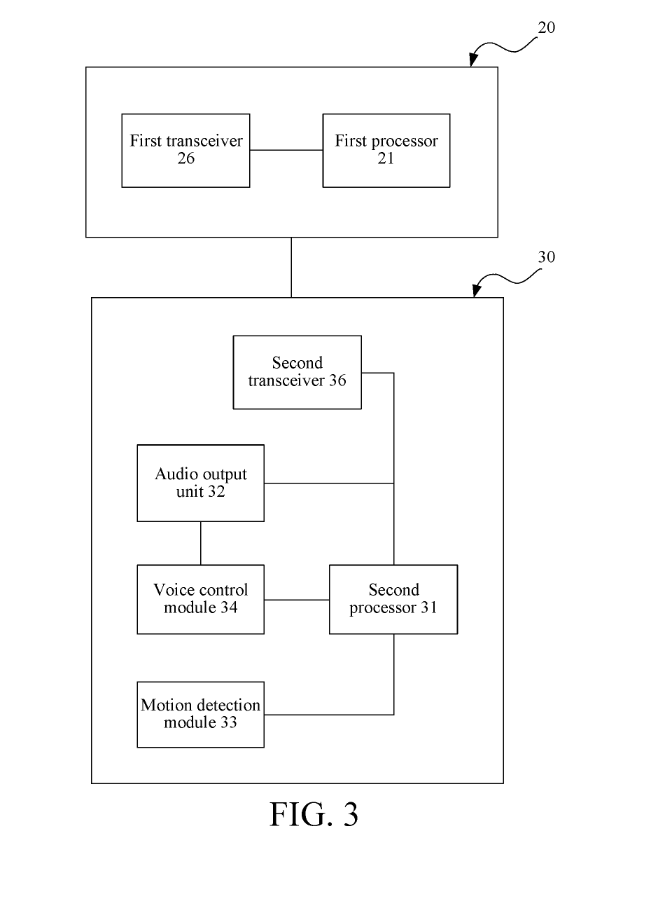

The present disclosure further provides a loudspeaker system, particularly applicable to multi-room application, so that the system is extended to a plurality of speakers. Referring to FIG. 3, the loudspeaker system includes: a first speaker apparatus 20 and a second speaker apparatus 30, where the first speaker apparatus 20 may be defined as a main audio system, the second speaker apparatus 30 may be defined as a sub audio system. Although the figure shows only one second speaker apparatus 30, according to a requirement (for example, a plurality of rooms), there may be a plurality of second speaker apparatuses 30. That is, the figure is not used to limit the present disclosure.

The first speaker apparatus 20 includes: a first processor 21 and a first transceiver 26. The first processor 21 herein is a host processor, and is also a main processing part in the loudspeaker system. The first transceiver 26 is electrically connected to the first processor 21. The second speaker apparatus 30 includes: a second transceiver 36, a second processor 31, an audio output unit 32, a motion detection module 33, and a voice control module 34. The second processor 31 is electrically connected to the second transceiver 36, the audio output unit 32, the motion detection module 33, and the voice control module 34 respectively. Although not shown in the figure, it should be understood by a person skilled in the art that the first speaker apparatus 20 may be further provided with an audio output unit, a motion detection module, and a voice control module. However, to simplify description, the audio output unit, the motion detection module, and the voice control module, and their descriptions are omitted from the first speaker apparatus 20 in the figure. The second speaker apparatus 30 mainly implements the signal and command transmitted by the first speaker apparatus 20, and further description is provided below.

In the embodiment of FIG. 3, when the motion detection module 33 detects a motion of a user, the second transceiver 36 is enabled by means of the second processor 31 to transmit the motion signal detected by the motion detection module 33 to the first transceiver 26. The first processor 21 outputs a control signal according to the detected motion, and the control signal is transmitted through the first transceiver 26 to the second transceiver 36, to enable the second processor 31 to control an output signal (for example, output volume reduction, an equalizer parameter, or multi-channel adjustment and distribution) of the audio output unit 32. In this case, when the user controls the loudspeaker system with a voice command, the voice control module 34 receives a voice command of the user, enables the second transceiver 36 by means of the second processor 31 to transmit the voice command to the first transceiver 26, and enables the first processor 21 to control an operation (for example, an operation such as switching on or off the speaker, changing a radio station, changing a song, and adjusting a melody) on the loudspeaker system 10.

In an embodiment, the audio output unit 32 is electrically connected to the voice control module 34, the audio output unit 32 feeds back a sound signal to the voice control module 34, and in this case, the voice control module 34 implements AEC.

In some embodiments, to reduce the hardware costs of the second speaker apparatus 30 and make it easier for a user to obtain an effect of multi-room application (that is, a plurality of rooms are all equipped with the second apparatuses 30 respectively), a processor, compared with the first processor 21 of the first speaker apparatus 20, having a weaker processing capability is used as the second processor 31 of the second speaker apparatus 30, thereby lowering manufacturing costs of the second speaker apparatus 30. To be specific, in some embodiments, the first processor 21 may be a higher-level product, and the second processor 31 may be a lower-level product. Because the first processor has a higher operation processing capability, in the loudspeaker system disclosed in the present disclosure, most or all operation programs may be handed to the first processor for operation processing, or a program with a heavy operation processing load is dynamically allocated to the first processor for operation processing, thereby improving an command transmission of the entire loudspeaker system.

In another embodiment, the second transceiver of the second speaker apparatus may alternatively be set to be only connected to the first transceiver of the first speaker apparatus, so that the second transceiver does not have a function of connecting to an external network. To be specific, the second transceiver, compared with the first transceiver, may be a lower-level product, so as to further lower hardware costs of the second speaker apparatus.

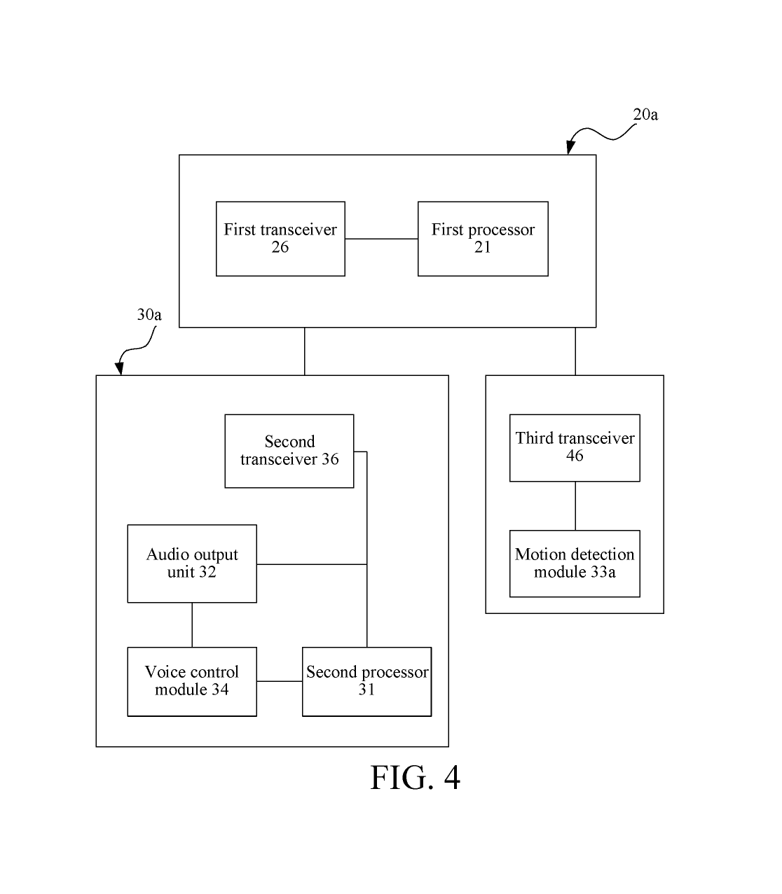

Referring to FIG. 4, the following is an embodiment of multi-room application of another loudspeaker system, including: a first speaker apparatus 20a, a second speaker apparatus 30a, a motion detection module 33a, and a third transceiver 46. The greatest difference between this embodiment and the embodiment of FIG. 3 is that the motion detection module 33a is a standalone accessary disposed additionally. Therefore, a transceiver is further needed to help signal transmission. The first speaker apparatus 20a includes: a first processor 21 and a first transceiver 26. The first transceiver 26 is electrically connected to the first processor 21. The second speaker apparatus 30a includes: a second transceiver 36, a second processor 31, an audio output unit 32, and a voice control module 34. The second processor 31 is electrically connected to the second transceiver 36, the audio output unit 32, and the voice control 34 respectively. The motion detection module 33a is electrically connected to the third transceiver 46.

Similar to FIG. 3, the first speaker apparatus 20a of FIG. 4 may further be provided with an audio output unit, a motion detection module, and a voice control module. However, to simplify description, the audio output unit, the motion detection module, and the voice control module, and their descriptions are omitted from the first speaker apparatus 20a in the figure.

When the motion detection module 33a detects a motion of a user, the third transceiver 4 transmits a detected motion signal to the first transceiver 26. The first processor 21 outputs a control signal according to the detected motion signal, and the control signal is transmitted through the first transceiver 26 to the second transceiver 36, to enable the second processor 31 to control an output signal (for example, output volume reduction, an equalizer parameter, or multi-channel adjustment and distribution) of the audio output unit 32. When the user controls the loudspeaker system with a voice command, the voice control module 34 receives a voice command, enables the second transceiver 36 by means of the second processor 21 to transmit the voice command to the first transceiver 26, and enables the first processor 21 to control an operation (for example, an operation such as switching on or off the speaker, changing a radio station, changing a song, and adjusting a melody).

In an embodiment, the audio output unit 32 is electrically connected to the voice control module 34, the audio output unit 32 feeds back a sound signal to the voice control module 34, and in this case, the voice control module 34 implements AEC.

The connection line in the figures is not only a physical line, but represent an electrical connection. To be specific, the connection line may be a physical line or a wireless connection (for example, a connection such as a Bluetooth connection or a WiFi network connection), including a unidirectional communication and/or a bi-directional communication.

As used herein, the term “module” refers to an application specific integrated circuit (ASIC), an electronic circuit, a microprocessor, a computer processor (shared, dedicated, or group) and memory that executes one or more software or firmware programs, a combinational logic circuit, a microcontroller including various inputs and outputs, and/or other suitable components that provide the described functionality. The module is configured to execute various algorithms, transforms, and/or logical processes to generate one or more signals of controlling a component or system. When implemented in software, a module can be embodied in memory as a non-transitory machine-readable storage medium readable by a processing circuit (e.g., a microprocessor) and storing instructions for execution by the processing circuit for performing a method. A controller refers to an electronic hardware controller including a storage unit capable of storing algorithms, logic or computer executable instruction, and that contains the circuitry necessary to interpret and execute instructions.

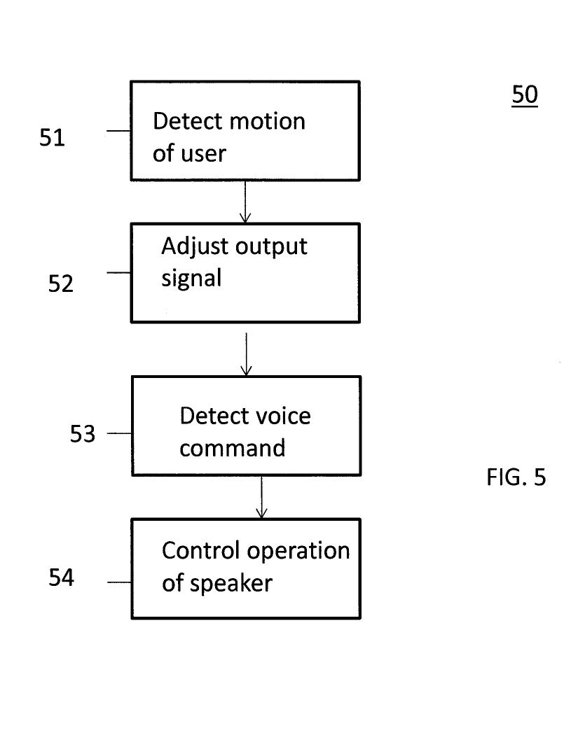

The present disclosure provides a method 50 (see FIG. 5) of controlling a speaker, including: detecting a motion of a user 51; adjusting an output signal of the speaker according to the detected the motion 52; detecting a voice command of the user 53; and controlling an operation on the speaker according to the voice command 54.

The method of the present invention may be executed by software, particularly, in cooperation with configuration of the forgoing embodiments. The configuration of each embodiment is described in detail above, and is not described herein again.

In conclusion, the loudspeaker system according to the present disclosure can control a voice command better by using a motion of a user and can, with respect to a voice-controlled loudspeaker system, provide better user experience.

Although embodiments of the present invention are disclosed as above, they are not intended to limit the present invention. Any person skilled in the art may make some variations and modifications without departing from the spirit and scope of the present invention. Therefore, the protection scope of the present disclosure shall be subject to the scope defined in the appended claims.

What is claimed is:

1. A loudspeaker system, comprising:
a host processor;
an audio output unit, electrically connected to the host processor;
a motion detection module, electrically connected to the host processor and configured to detect a motion of a user; and
a voice control module, electrically connected to the host processor,
wherein the host processor is configured to control an output signal of the audio output unit according to the motion detected by the motion detection module, and the voice control module is configured to receive a voice command enabling the host processor to control an operation of the loudspeaker system.

2. The loudspeaker system according to claim 1, further comprising a main body,
wherein the host processor, the audio output unit, and the voice control module are disposed within the main body, and the motion detection module is a standalone unit outside of the main body.

3. The loudspeaker system according to claim 1, wherein the host processor is configured to control the output signal of the audio output unit to lower a volume of the loudspeaker system, the audio output unit is electrically connected to the voice control module, and the voice control module is configured to implement automatic echo cancellation.

4. A loudspeaker system, comprising:
a first speaker apparatus, comprising:
a first processor; and
a first transceiver electrically connected to the first processor; and
a second speaker apparatus, comprising:
a second transceiver;
a second processor electrically connected to the second transceiver;
an audio output unit electrically connected to the second processor;
a motion detection module electrically connected to the second processor and configured to detect a motion of a user; and
a voice control module electrically connected to the second processor,
wherein the second transceiver is configured to transmit a detected motion signal detected by the motion detection module to the first transceiver, the first processor is configured to output a control signal according to the detected motion signal, and the control signal is transmitted through the first transceiver to the second transceiver, to enable the second processor to control an output signal of the audio output unit, and
wherein the voice control module is configured to receive a voice command and transmit the voice command to the first transceiver through the second processor and the second transceiver, to enable the first processor to control an operation.

5. The loudspeaker system according to claim 4, wherein the second speaker apparatus further comprises a main body,
wherein the second processor, the audio output unit, and the voice control module are disposed within the main body, and the motion detection module is a standalone unit outside of the main body.

6. The loudspeaker system according to claim 4, wherein the first processor is configured to control the output signal of the audio output unit to reduce the volume of the loudspeaker, the audio output unit is electrically connected to the voice control module, and the voice control module is configured to implement automatic echo cancellation.

7. A loudspeaker system, comprising:
a first speaker apparatus, comprising:
a first processor; and
a first transceiver, electrically connected to the first processor;
a second speaker apparatus, comprising:
a second transceiver;
a second processor electrically connected to the second transceiver;
a audio output unit electrically connected to the second processor; and
a voice control module electrically connected to the second processor;
a motion detection module configured to detect a motion of a user; and
a third transceiver electrically connected to the motion detection module,
wherein the third transceiver is configured to transmit a detected motion signal detected by the motion detection module to the first transceiver, the first processor is configured to output a control signal according to the detected motion signal, and the control signal is transmitted through the first transceiver to the second transceiver, to enable the second processor to control an output signal of the audio output unit, and
wherein the voice control module is configured to receive a voice command and transmit the voice command to the first transceiver through the second processor and the second transceiver, to enable the first processor to control an operation.

8. The loudspeaker system according to claim 7, wherein the first processor is configured to control the output signal of the audio output unit to lower a volume of the loudspeaker system, the audio output unit is electrically connected to the voice control module, and the voice control module is configured to implement automatic echo cancellation.

9. A method of controlling a speaker, comprising:
detecting a motion of a user;
adjusting an output signal of the speaker according to the detected motion;
detecting a voice command of the user; and
controlling an operation on the speaker according to the voice command.
